(19) United States
(12) Patent Application Publication
(10) Pub. No.: US 2020/0123839 A1
(43) Pub. Date: Apr. 23, 2020

(54) LATTICE WALL FOR A SECURITY CAGE

(71) Applicant: INVENTOR JAM AB, Sollentuna (CN)

(72) Inventor: Jarmo SÄÄF, Sollentuna (SE)

(21) Appl. No.: 16/618,489

(22) PCT Filed: Jun. 7, 2018
(86) PCT No.: PCT/EP2018/065046

§ 371 Date: Dec. 2, 2019

(30) Foreign Application Priority Data
Jun. 7, 2017 (EP) 17174770.2

(51) Int. Cl. E05G 1/024

(52) U.S. Cl. CPC E05G 1/024

(57) ABSTRACT

A modular system for assembling at least one lattice wall for a security cage. The system comprises; a plurality of elongate hollow intermediate posts (10, 20a, 20b) arranged to be mounted side by side in at least one row, the intermediate posts thereby extending in parallel in a first direction, each post exhibiting a number of transverse primary through openings (11, 21) arranged in pairs along the post, the primary trough openings of each pair being aligned in a second direction which is perpendicular to the first direction. A plurality of elongate first bars (30) are arranged to be mounted side by side in parallel, extending in the second direction, by insertion through respective pairs of said through openings (11, 21) in a plurality of intermediate posts (10, 20a, 20b) arranged side by side in said row. At least two locking posts (40a, 40b) are arranged to be secured to a first (20a) and a last (20b) intermediate post in said row of intermediate posts. The system further comprises securing means (24, 25, 44) for securing the locking posts (40a, 40b) to respective end sides of said first (20a) and last (20b) intermediate posts, which end sides faces away from each other, thereby to lock the first bars (30) from being removed by displacement in the second direction.

### FIELD OF THE INVENTION

The invention relates to a modular system for assembling a lattice wall for a security cage. The modular system may also be used for assembling a security cage comprising a plurality of lattice walls. The invention also relates to a method of assembling such a lattice wall.

### BACKGROUND

Security cages are used in many applications for creating a space with access only to authorised persons. Typically the security cages are set up in warehouses or other indoor spaces for protecting valuable goods or items that contain or secret information. An example of such applications is server centres where single or groups of servers should be protected in individual cages with access only for certain persons. Another example is rental storage facilities, housing several storage spaces each of which should be accessible only for a limited number of persons.

Such security cages may be constructed with several different degrees of security from comparatively simple arrangements comprising corner posts and some kind of metallic net to high security arrangements comprising lattice walls made of high strength vertical posts and horizontal bars. For classifying the security degree there has been developed a European Standard (DIN EN 1627) which classifies security cages and other constructional elements into several classes, RC 1 to RC 6, depending on how long time it takes to force open the security cage or other element using different tools.

The present invention relates primary to the construction and assembling of lattice walls for security cages exhibiting a high security corresponding to DIN EN 1627 RC 4 and above. However, the modular system according to the invention may also be used for assembling security cages of lower security classes.

Besides of that the security cages should exhibit a satisfying security level it is also important that they are easy to assemble and that the dimensions of the lattice walls and the entire cage should be easily adjustable to different demands and requirements of the available space.

### PRIOR ART

GB 2 305 945 A discloses a security cage comprising a frame made of vertical and horizontal bars covered by a diamond steel mesh. The security cage exhibits four side walls, a roof and a door arranged in one of the side walls.

KR 101529472 B1 discloses a server cage comprising upper and lower channels arranged to be fixed to a ceiling and a floor of a building. A wall of a server cage is formed by inserting fence members into the channels.

U.S. Pat. No. 207,476 A discloses a grating comprising vertical flat bars and horizontal flat bars which are secured to the vertical flat bars. A number of vertical pipes extend through the horizontal flat bars and are riveted to the uppermost and lowermost horizontal flat bar. A solid rod is rotationally received in each vertical pipe.

U.S. Pat. No. 5,813,187 A discloses a metal barrier for a window or door comprising a rectangular frame having plug holes on the inside of two opposite vertical sides and two opposite horizontal sides. Horizontal metal tubes extend between vertical frame members and are received in respective plug holes. Vertical metal tubes extend between horizontal frame members through holes in the horizontal tubes and are received in plug holes in the horizontal frame members.

### SUMMARY OF THE INVENTION

It is an object for the present invention to provide an enhanced modular system for assembling a lattice wall for a security cage.

Another object is to provide such a system which allows for that the resulting lattice wall or security cage exhibits a high degree of security.

A further object is to provide such a system which allows for that the dimensions of the lattice wall and security cage may readily be adapted within wide ranges.

Still another object is to provide such a system which allows for that the lattice wall and security cage may readily be assembled on site without the need for any onsite cutting or other machining of the modular components.

Yet another object is to provide such a system which allows for that the lattice wall and security cage may be assembled by modular components which are comparatively small, light and easy to transport to the site where the lattice wall and security cage is to be erected.

These and other objects are achieved by a modular system as defined by appended claim 1. The modular system is intended for assembling at least one lattice wall for a security cage. The modular system comprises a plurality of elongate hollow intermediate posts arranged to be mounted side by side in at least one row, the intermediate posts thereby extending in parallel in a first direction, each post exhibiting a number of transverse primary through openings arranged in pairs along the post, the primary trough openings of each pair being aligned in a second direction which is perpendicular to the first direction. A plurality of elongate first bars are arranged to be mounted side by side in parallel, extending in the second direction, by insertion through respective pairs of said through openings in a plurality of posts arranged side by side in said row. At least two locking posts are arranged to be secured to a first and a last intermediate post in said row of intermediate posts. The system further comprises means for securing the locking posts to respective end sides of said first and last intermediate posts, which end sides faces away from each other, thereby to lock the first bars from being removed by displacement in the second direction.

The invention thus provides a modular system for assembling at least one lattice wall of a security cage. The security cage may comprise one or several 3o such lattice walls and the wall or walls may constitute a side wall, a top wall and/or a bottom wall. In cases where the security cage comprises only one lattice wall, the other walls defining the security cage may be formed of existing walls, ceiling and floor of a building in which the security wall is to be constructed. In such cases the single lattice wall assembled by the modular system may be arranged to extend between two of said building walls or to block access through an opening in one of the building walls. Alternatively a single lattice wall may be arranged between two building walls extending at an angle to each other to thereby define a triangular security cage. Where the security cage is to be arranged in a corner of a building, two lattice walls may be assembled and secured to each other at an angle and to the two building walls. When needed, a lattice wall assembled from the modular system may also be used for forming a ceiling and/or a floor of a security cage at which the side walls are formed by lattice walls assembled from the modular system and/or by building walls.

The modular system allows for that the intermediate posts, the first bars and the locking posts are given appropriate lengths before delivery to the site where the security cage is to be erected, such that no cutting or other machining is necessary onsite. This affords for a great advantage since cutting or other machining may causes noise, sparks, heat, chippings, dust and other pollutions which are often not allowed at the sites where the security cage is to be erected. This applies e.g. at server centres where already installed servers are extremely sensitive to such pollutions. Additionally, the assembly of the lattice walls and security cage requires no welding, soldering or other heat generating or otherwise disturbing joining operations. The inventive modular system thus allows for that the lattice walls and entire security cages may readily be assembled onsite with a minimum of disturbance to other activities, persons and equipment at the site.

Further more, only the precise number of intermediate posts, first bars and locking posts need to be transported to the site. Since these modular 3o components are all elongate and slender they are easy to transport and to bring into a building housing the assembly site. This affords a great advantage in comparison to previously known systems for erecting security cages which often comprise premanufactured entire lattice wall sections which are bulky, heavy and difficult to bring into the site and which may require considerable space onside for being erected and joined together.

The arrangement of the locking posts and the securing means for securing these to oppositely facing end sides of the first and last intermediate posts further provides a very efficient manner for blocking the first bars from longitudinal displacement and to thereby interlock relative movement between the intermediate posts and the first bars. In this manner, the components forming the lattice wall are mutually interlocked such that disassembling of the lattice wall requires either the releasing of the securing means or cutting or breaking of the intermediate posts or the first bars. A very high security level may thus be provided by using high strength material in the intermediate posts and first bars and by preventing release of the security means. The later may easily be achieved by blocking access to the securing means.

The securing means may comprise screws and screw holes arranged in the locking posts and in the first and last intermediate posts.

The cross section of the intermediate posts may be rectangular, preferably square.

The cross section of the locking posts may be equal to the cross section of the intermediate posts. This allows for that the modular components forming the intermediate posts and the locking posts may be manufactured from identical tubular blanks.

The modular system may further comprise elongate second bars arranged to be inserted longitudinally in the intermediate posts. Such internal bars, extending along the entire length of the intermediate posts, add material which has to be penetrated or cut at an attempt to break through the lattice wall. Thereby the time needed for breaking through the lattice work is increased and the security level is raised correspondingly.

The plurality of intermediate posts may comprise at least two end posts which are arranged to constitute said first and last intermediate posts in the row of intermediate posts, wherein the end posts and the locking posts exhibit respective screw holes which are arranged for securing a locking post to a respective end post by treading a screw into the locking post from the side of the end post being opposite to the locking post. By this means the end posts and the locking posts may be prefabricated with corresponding screw holes arranged for the fixation of the locking posts, whereas the remainder of the intermediate post need not to be prefabricated with such screw holes.

The modular system may further comprise a plurality of fastening brackets, each fastening bracket comprising a support portion arranged to be secured to a surrounding floor, wall or ceiling and an insertion portion arranged to be adjustably inserted into an end portion of an intermediate post and secured thereto at a desired insertion depth. This allows for that the intermediate posts and thereby the entire lattice wall may be readily and securely fixed to the floor, ceiling and/or walls of the building in which the security cage is to be erected. The adjustability of the fastening brackets further allows for that the lattice wall is readily assembled also at sites where the supporting floor, ceiling and/or walls are not flat or levelled.

The modular system may further comprise a plurality of joint brackets arranged to be longitudinally inserted into respective end portions of a first and a second intermediate post and secured thereto for longitudinal extension of the intermediate posts. By this means the length of the lattice wall in the first direction may easily be adjusted to the required length.

The intermediate posts may comprise a number of screw holes corresponding to the number of pairs of primary through openings, each screw hole being arranged perpendicular to an in level with a pair of primary through openings for securing a first bar extending through said pair of primary through openings. By this means an additional fastening of the first bars to the intermediate posts is achieved. Such additional fastening may facilitate the assembly work and prevents vibration of the first bars after assembly.

At least one intermediate post may comprise a number of screw holes arranged in pairs side by side at a respective pair of primary through openings for securing a respective one of two first bars extending through a respective primary through opening of each pair of primary through openings. Such an arrangement may be advantageous at installations where the length of the lattice wall in the second direction is longer than the length of the first bars. At such installations, the intermediate posts exhibiting secondary through openings arranged in pairs may be used as joints between two first bars arranged longitudinally aligned.

The modular system may further comprise blocking means for preventing removal of the securing means when the locking posts have been secured to the first and last intermediate posts. By this means disassembly of the lattice wall is prevented or at least made considerably more difficult.

The securing means may comprise at least one screw with a screw head exhibiting a recess or a protrusion for being engaged by a tool and the blocking means may comprise a blocking element arranged to be forced into permanent engagement with said recess or protrusion for preventing insertion of a tool. The blocking element may e.g. be formed of a steel ball or similar which is forced into permanent engagement with the tool recess of the securing screw after assembly of the lattice wall. This allows for an easy way to considerably increasing the security level of the lattice wall.

The intermediate posts, the first bars and the locking posts may comprise or be at least predominantly formed of steel. By this means cutting or otherwise breaking these components is made difficult and the security of the lattice wall is correspondingly increased.

The second bars may have circular cross section. This allows for that the second bars are rotated at an attempt to cut the intermediate posts by sawing such that such cutting of the intermediate is rendered considerably more difficult.

In addition or alternatively the second bars may comprise or be predominantly formed of hardened steel which further prevents cutting of the intermediate posts.

The invention also relates to a method of assembling a lattice wall of a security cage. The method comprises the steps of;
providing a plurality of elongate hollow intermediate posts, each post exhibiting a number of transverse primary through openings arranged in pairs along the post, the primary trough openings of each pair being aligned in a second direction which is perpendicular to the first direction,
providing a plurality of elongate first bars,
providing two locking posts,
arranging the intermediate posts in a row one after the other with an interspace, such that the intermediate posts are arranged in parallel in a first direction,
inserting first bars into respective pairs of primary through openings of each intermediate post, such that the first bars are received in a first and a last intermediate post in said row but do not protrude out from respective end sides of said first and last intermediate posts, which end sides faces away from each other,
securing a locking post to each of said end sides of the respective first and last intermediate post.

The method exhibits generally the same objectives and advantages as the modular system. Further objectives and advantages of the modular system and the method will appears from the following detailed description of embodiments and from the appended claims

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a plan view of a lattice wall assembled by a modular system according to an embodiment of the invention.

FIG. 2a is a perspective view of a portion of a security cage comprising two lattice walls assembled by a modular system according to the invention and FIG. 2b is an exploded perspective view of a portion of a similar security cage.

FIG. 3 is a cross section of a detail in enlarged scale of the lattice wall shown in FIG. 1.

FIG. 4a is a plan view of one side of an intermediate post comprised in the modular system, FIG. 4b is a plan view of an orthogonal side and FIG. 4c is an elevation view thereof.

FIGS. 5a-c are views corresponding to those of FIGS. 4a-c of an end post comprised in the modular system.

FIGS. 6a-c are corresponding views of a locking post comprised in the modular system.

FIGS. 7, 8 and 9 are perspective views of respective additional components comprised in the modular system.

FIG. 10 is a perspective view of a portion of another security cage comprising lattice walls assembled by the modular system.

### DESCRIPTION OF EXEMPLIFYING EMBODIMENTS

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

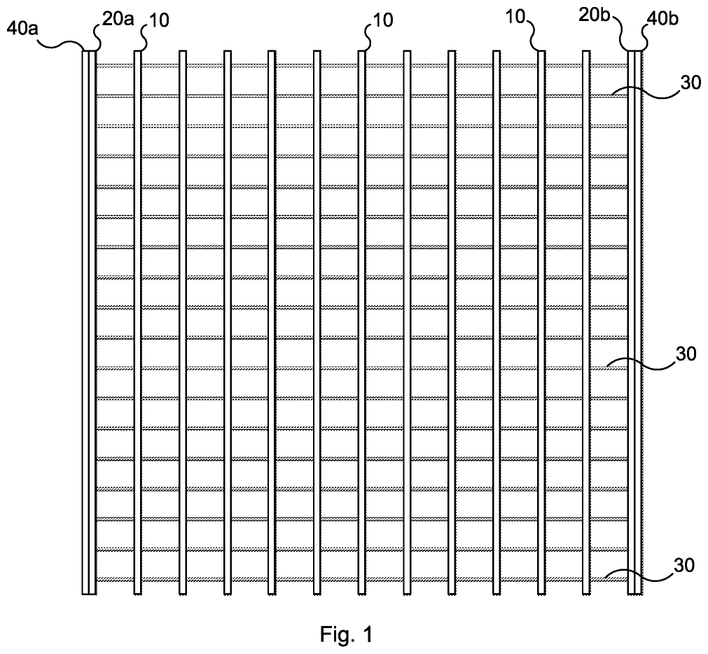

FIG. 1 shows a lattice wall for a security cage, which lattice wall has been assembled from a modular system according to the invention. The modular system and the assembled lattice wall comprises a number of first intermediate posts 10, two second intermediate posts 20a, 20b, a number of first bars 30 and two locking posts 40a, 40b. In the example shown in FIG. 1, the lattice wall comprises thirteen intermediate posts 10, 20a, 20b extending in parallel to each other in the vertical direction and eighteen first bars 30 extending in the horizontal direction. The first and second intermediate posts 10, 20a, 20b are arranged one after the other in a straight row where the two second intermediate posts 20a, 20b are positioned as a first and a last post at a respective end of the row and constitute end posts which differ slightly to the first intermediate posts 10 as will be explained below.

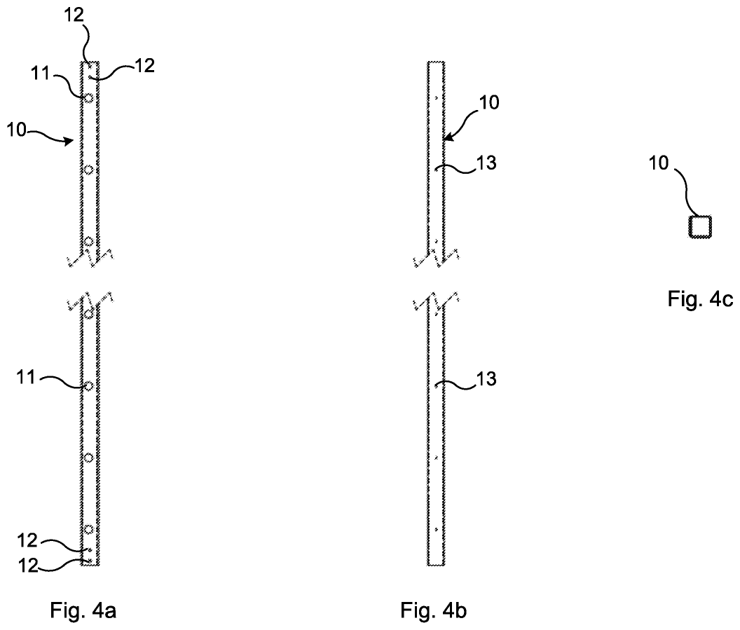

As best seen in FIGS. 4a-c, the first intermediate posts 10 are constituted by elongate hollow profile elements having square cross section. In the shown example the cross section dimensions are 40×40×3 mm and the length of the posts is approx. 3 000 mm. Two opposing sides of the first intermediate posts 10, one of which sides is shown in FIG. 4a, is provided with an number of primary through openings ii aligned one after the other along the first intermediate posts. The primary through openings 11 at the opposing sides are arranged in pairs such that the primary through openings of one side are aligned coaxially with a respective primary through opening on the opposite side. The line of alignment for the two primary through openings 11 in each pair extend perpendicularly to the longitudinal direction of the primary post 10. When the lattice wall has been assembled as shown in FIG. 1, the longitudinal direction of the intermediate posts extend vertically whereby the primary through openings in each pair of primary through openings 11 are aligned horizontally. In the shown example the primary through openings are circular with a diameter of approx. 16 mm, this for receiving circular first bars 30 having a diameter of approx. 16 mm with a slight play. As seen in FIG. 4a the primary through openings 11 are slightly offset with respect to the longitudinal centre line of the first intermediate posts 10.

Said opposing sides of the first intermediate posts 10 are also provided with first screw holes 12 arranged in proximity to both longitudinal ends of the first intermediate posts. As will be explained below, these first screw holes are arranged for fixation of additional components of the modular system.

As illustrated in FIG. 4b, the two opposing sides being arranged perpendicular to the sides provided with primary through openings 11 are provided with a number of second screw holes 13 distributed over the length of the first intermediate post and aligned along the longitudinal centre line of this post.

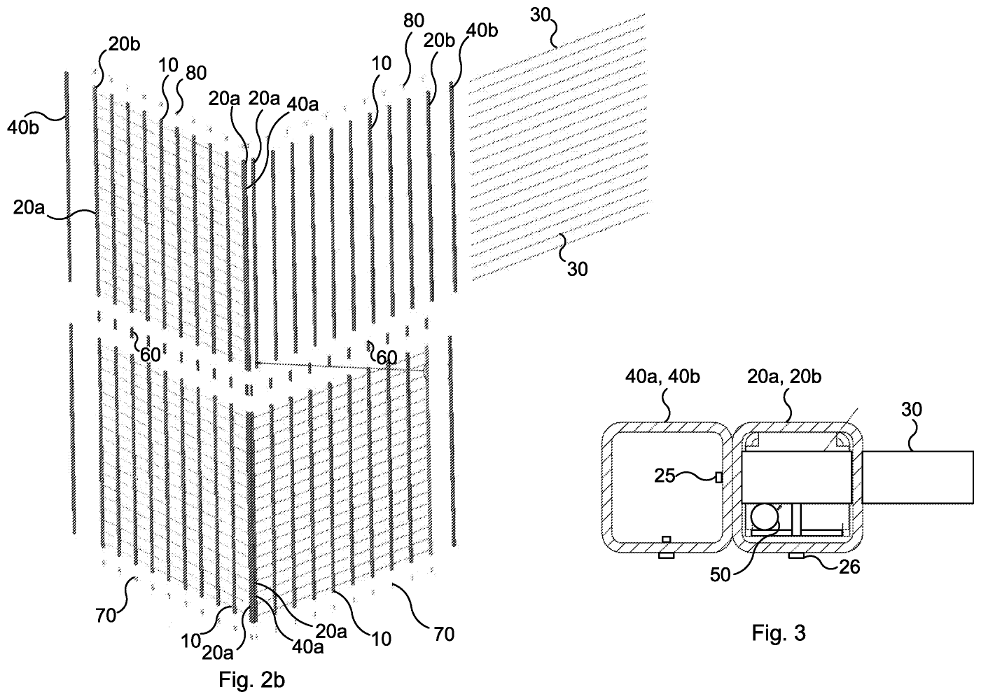

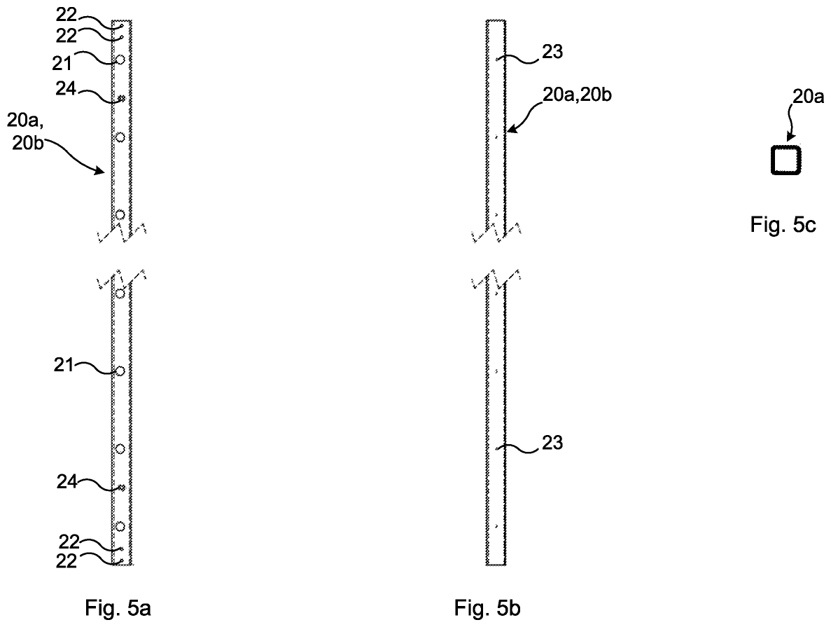

FIGS. 5a-c illustrate one of the two second intermediate post 20a, 20b which are identical. The second intermediate posts 20a, 20b are identical to the first intermediate posts 10 with respect to the dimensions, the pairs of primary through openings 21, the first screw holes 22 and the second screw holes 23. In addition the second intermediate posts 20a, 20b, constituting end posts are provided with third screw holes 24 arranged in the opposing sides exhibiting the primary through holes 21. Also the third screw holes 24 are arranged in pairs where the two screw holes in a pair of third screw holes 24 are aligned perpendicularly to the longitudinal extension of the second intermediate post 20. However, the diameter of the third screw holes arranged at a first side is somewhat greater than the diameter of the third screw holes arranged at the opposing second side, such that a screw driver or a corresponding tool may be inserted through the larger screw holes from the first side for rotational fixation of a screw 25 (see FIG. 3) exhibiting a screw head arranged inside the second intermediate post, which screw extends from the inside of the second intermediate post 20 through the smaller third screw hole.

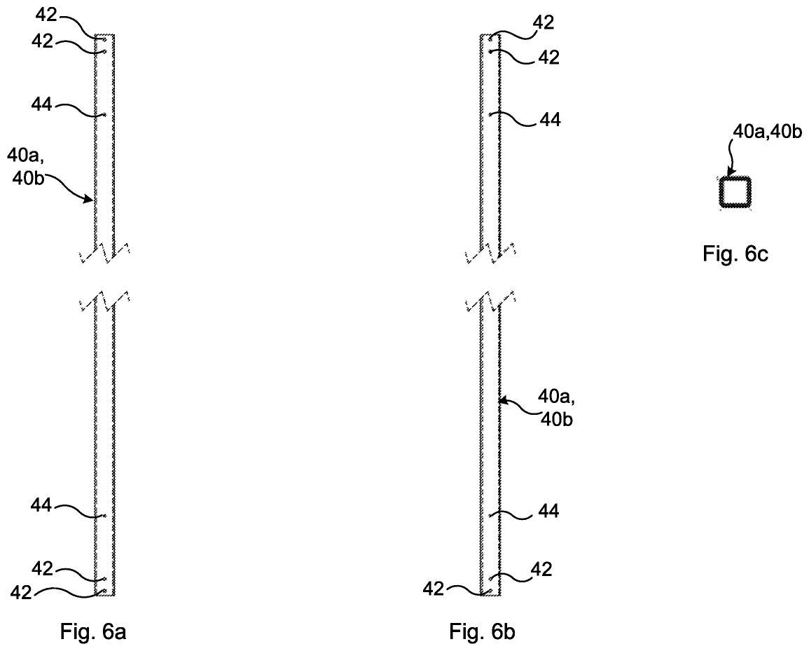

FIGS. 6a-c illustrate one of the two locking posts 40a, 40b, which are identical. Also the locking posts 40a, 40b have the same dimensions as the first 10 and second 20a, 20b intermediate posts shown in FIGS. 4a-c and 5a-c. The locking posts 40a, 40b does not exhibit any primary through openings or second screw holes of the kind described above. However, all four sides of the locking posts 40a, 40b are provided with first screw holes 42 corresponding to the first screw holes 12, 22 of the first 10 and second 20a, 20b intermediate posts for fixation of additional modular components. All four sides of the locking posts 40a, 40b are also provided with third screw holes 44 positioned to be aligned with the third screw holes 24 of the second intermediate posts 20a, 20b when a locking post 40a, 40b is secured to a second intermediate post 20a, 20b. The third screw holes 44 have a diameter for threadedly receiving a fixation screw 25 (see FIG. 3), the threaded portion of which screw 25 extends from the inside of a second intermediate post 20a, 20b, through one of the smaller third screw hole of the second intermediate post. For this purpose the third screw holes 44 of the locking posts 40a, 40b may be provided with internal treads. However, in cases where the fixation screws 25 are self-tapping, the third screw holes 44 of the locking posts 40a, 40b need not be provided with internal threads.

Referring to FIGS. 1 and 3 the lattice wall shown in FIG. 1 is assembled in the following manner. First, the intermediate posts 10, 20a and 20b are arranged in a rectilinear row one after the other such that the second intermediate posts 20a, 20b are positioned as a first and a last intermediate post in the row. All intermediate posts 10, 20a, 20b are arranged in parallel to each other, extending in the vertical direction and oriented such that the primary through openings 11, 21 at different vertical levels form horizontally aligned passages for respective circular first bars 30 having a diameter which is somewhat smaller than the primary through openings. The intermediate posts 10, 20a, 20b are mutually separated at a certain distance depending on the security class to be achieved. If, for instance the security class of the resulting lattice wall should be RC 4 the CC distance should be less than 270 mm and a suitable CC distance is approx. 250 mm. For the same security class the cc distance between the first bars should be less than 200 mm and is in this example chosen to be approx. 170 mm.

Thereafter, a first bar 30 is inserted in each passage formed by respective primary through openings 30. Now, all or some of the horizontal first bars 30 may be secured to some or all of the intermediate posts 10, 20a, 20b by screwing fixation screws 26 (FIG. 3) into the second screw holes 13, 23 of the intermediate posts 10, 20a, 20b such that the tip of the fixation screws 26 presses the first bars 30 radially into frictional engagement with the edges of the primary through openings 11, 21. By this means the first bars 30 and the intermediate posts 10, 20a, 20b are interlocked and the lattice wall is stabilized. Additionally, it results in that vibrations of the first bars 30 are prevented. Alternatively, such securing of the first bars 30 may be carried out later. At some instances, e.g. when the locking posts 40a, 40b and/or the end posts 20a, 20b are secured to the building, such fixation of the first bars may be omitted.

After that all first bars 30 have been inserted into the primary through openings 11, 21 the locking posts 40a, 40b are aligned with a respective one of the end posts 20a, 20b and secured thereto. This is accomplished by inserting fixation screws 25 (FIG. 3) through the larger third screw holes 24 and further through the respective smaller third screw holes of the end posts and threadedly engaging the fixation screws with respective third screw holes 44 of the locking posts 40a, 40b. This may be accomplished by inserting a screw driver or a similar tool through the larger screw holes 24 and engaging it with a tool recess of the screw head which then is positioned inside the end post 20a, 20b. Since the locking posts 40a, 40b do not exhibit any primary through openings, the ends of the first bars 30 are hereby prevented from protruding outwardly from the primary through openings 21 facing outwardly, away from each of the two end posts 20a, 20b and the primary bars 30 are thereby locked in position by being prevented from horizontal displacement.

In order to increase the security of the lattice wall, unauthorized removal of the fixation screws 25 may be prevented in different ways. For instance, it is possible to form the tool engagement recess or protrusion of the fixation screws 25 such that a special tool or key is required for unscrewing the fixation screw. Alternatively, the modular system may comprise blocking elements (not shown) which are forced into permanent engagement with tool engaging recesses or protrusions of the fixation screws 25. Where the fixation screws exhibit tool engaging recesses the blocking elements may comprise e.g. steel balls that may by forced into engagement in the recesses and when the fixation screws exhibit tool engaging protrusions the blocking elements may comprise steel sleeves which are forced into engagement about the protrusions. Such permanent blocking of the fixation screws 25 prevents disassembly of the lattice wall and requires that at least some components of the lattice wall are cut or otherwise broken for passing the lattice wall.

As best seen in FIG. 3, the modular system may also comprise a number of second bars which are arranged to be inserted longitudinally into at least one, some or all of the intermediate posts 10, 20a, 20b. The second bars 50 are arranged for preventing the intermediate posts 10, 20a, 20b to be cut off by sawing or similar operations. For this purpose the second bars 50 are preferably formed of or predominantly comprise a high strength material such as hardened steel and have essentially the same length as the intermediate posts 10, 20a, 20b. In order to further increase the ability to withstand attacks by sawing or the like, the second bars 50 may exhibit a circular cross section such that they are prone to rotate about its longitudinal axis when contacted by a rotating or reciprocally moving cutting tool. As seen in FIG. 3 the off-centre positioning of the primary through openings 11, 21 in the intermediate posts 10, 20a, 20b increases the available space inside the intermediate posts 10, 20a, 20b at one side of the first bars 30, such that the diameter of the second bars 50 may be increased, thereby contributing to raising the security level of the lattice wall.

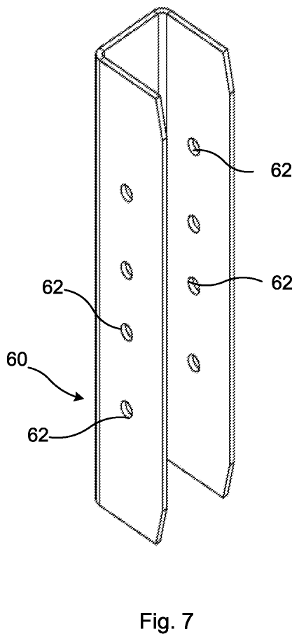

FIGS. 7-9 illustrate additional components which at some embodiments of the invention are comprised in the modular system.

FIG. 7 shows a joint bracket 60 which may be inserted in and secured to respective end portions of two intermediate and/or locking posts which are aligned longitudinally. This allows for the construction of lattice walls which have an extension in the first direction being parallel to the longitudinal direction of the posts, which exceeds the length of the intermediate and locking posts comprised in the modular system. The exemplifying joint bracket is a profile element with a U-shaped cross section having external dimensions which generally corresponds to the internal dimensions of the intermediate and locking posts 10, 20a, 20b 40a, 40b. By this means the joint bracket 60 may be inserted into respective ends of two posts and secured thereto by joint bracket fixation screws (not shown) which are inserted through the first screw holes 12, 22, 42 of the posts and threadedly engaged in corresponding joint bracket screw holes 62 arranged in the joint bracket. By arranging the joint bracket screw holes slightly offset from the first screw holes 12, 22, 42 it is possible to achieve a tightening effect by which the two longitudinally joined posts are forced towards each other when the joint bracket fixation screws are tightened. By this means any gap between the joined posts is eliminated or reduced and the stability of the joint is increased.

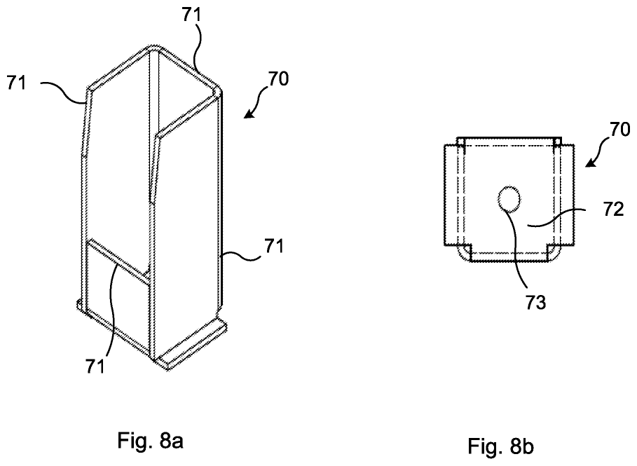

FIGS. 8a and 8b show a ground securing member 70 which is comprised in some embodiments of the modular system. The ground securing member 70 has a generally square cross section, the outer dimensions of which corresponds to the inner dimensions of the intermediate 10, 20a, 20b, and the locking 40a, 40b posts such that the ground securing member 70 may be inserted into a lower end of the posts. The ground securing member is formed in one piece by bending a steel blank and comprises side walls 71 and a bottom wall 72 joining the side walls 71. The bottom wall 72 exhibits a central through hole 73 for receiving a ground securing screw (not shown).

When assembling a lattice wall of a modular system comprising a number of such ground securing members 70, the method of assembling the lattice wall may comprise the step of positioning and securing a number of ground securing members at some or all positions on the ground floor where a vertical intermediate and/or locking post is to be positioned. The ground securing members are fixed to the ground floor by inserting fixations screws (not shown) from above through the central through hole 73 and threadedly engaging them with the ground floor. This step thus precedes the step of arranging the intermediate posts 10, 20a, 20b in a rectilinear row. When the ground securing members 70 have been correctly positioned and fastened to the ground floor, the lower ends of the posts 10, 20a, 20b are thread onto respective ground securing members 70. Thereafter the intermediate posts 10, 22a, 22b are levelled by adjusting the degree of insertion of the ground securing members 70 in the respective intermediate posts such that the primary openings 11, 21 of the intermediate posts are horizontally aligned. When this is done, each intermediate post 10, 20a, 20b is secured to the respective ground securing member 70 by inserting fixation screws (not shown) trough the lower first screw holes 12, 22 of the posts and threadedly engaging them with respective side walls 71 of the ground securing member. For this purpose, corresponding walls 71 of the ground securing member may be provided with a number of predrilled height adjustment holes (not shown) rectilinearly distributed in the vertical direction. This facilitates fastening of the fixations screws but it limits the height adjustability since only a limited number of height positions corresponding to the number of adjustment holes is then available. Instead and as indicated in FIG. 8a predrilled adjustment holes may be dispensed with and the fixation screws may be engaged with the walls 71, at any height position either by using self-tapping screws or by drilling a hole at the correct height position once the post has been levelled correctly.

An advantage of utilizing a ground securing member 70 of the kind described above is that the fixation screws (not shown) for fastening the ground securing member 70 and thereby the intermediate posts 10, 20a, 20b to the ground floor will be hidden inside the posts and thereby not accessible when the lattice wall has been erected.

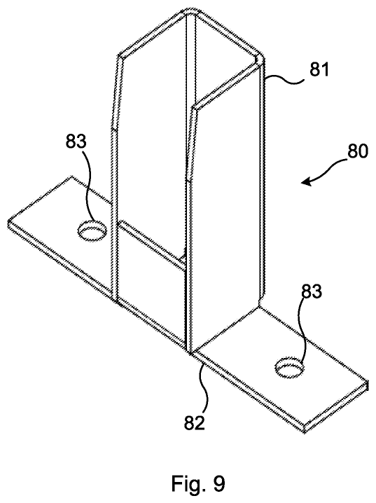

FIG. 9 illustrates an auxiliary securing member 80 which is comprised in some embodiments of the modular system according to the invention. The auxiliary securing member may be used for securing intermediate posts 10, 20a, 20b to walls, ceilings and other external elements of the building in which the lattice wall is erected. The auxiliary securing member 80 comprises an insertion portion 81 and a securing portion 82. The insertion portion has generally the same shape as the ground securing member 70 and may be adjustably inserted into an end portion of an intermediate post 10, 20a, 20b and fixed thereto at any desired relative longitudinal position as described above. The securing portion 82 comprises two flanges which extend laterally from the bottom of the insertion portion 81 and each flange comprises an auxiliary securing hole 83 for receiving an auxiliary fixation screw (not shown). By this means respective ends of the intermediate posts 10, 20a, 20b may easily be adjustably secured to any surrounding element. This may be accomplished by adjustably inserting the insertion portion 81 into the end of the intermediate post, securing the insertion portion 81 relative to the intermediate post by fixation screws extending through the first screw holes 12, 22 of the post and being threadedly engaged with the insertion portion as described above. Thereafter, the securing portion 82 may be secured to the surrounding element by inserting auxiliary fixation screws (not shown) through the auxiliary fixation holes and threadedly engaging them with the surrounding element.

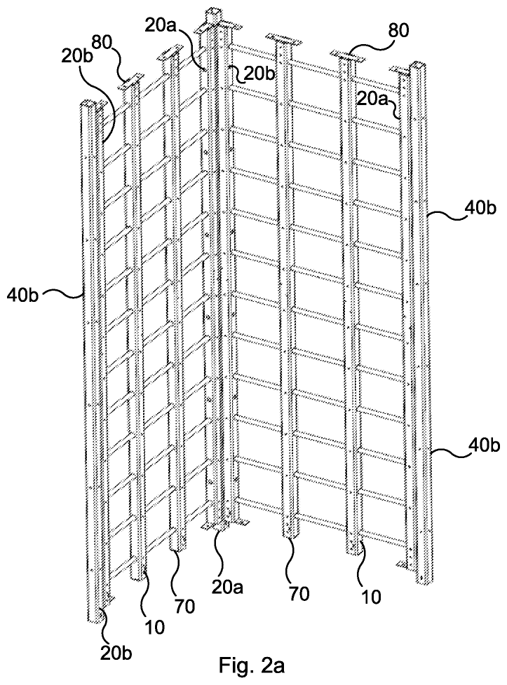

FIGS. 2a and 2b illustrate two examples of how a portion of a security cage comprising two lattice walls arranged perpendicularly has been assembled from a modular system according the invention. The so arranged portion of a security cage may form a complete security cage together with a floor, a ceiling and two walls of a building.

The portions of the security cages shown in FIGS. 2a and 2b each comprises first intermediate posts 10, second intermediate posts forming end posts 20a, 20b, first bars 30 and locking posts 40a, 40b. Each lattice wall is higher than the length of the intermediate posts 10, 20a, 20b and the intermediate posts 10, 20a, 20b have been prolonged by joining them longitudinally two by two by utilizing joint brackets 60 as described above. Since the locking posts 40a, 40b are fixed to respective end posts 20a, 20b as described above, it is not necessary to join the longitudinally aligned locking posts at each end of the two lattice walls by joint brackets. It should also be noted that the horizontal first bars 30 are locked in position by two aligned locking post 40b arranged at each distal end of the two lattice walls and a two aligned locking post 40b arranged at the proximal ends of the lattice walls. Each of the aligned proximal locking post 40a has been perpendicularly secured to two proximal end posts 20a by fixation screws (not shown) engaging the third screw holes 44 (see FIG. 6a-b) of the locking posts 40a. This is allowed since two orthogonal sides of the locking posts 40a are provided with the third screw holes.

Additionally all lower intermediate posts 10, 20a, 20b have been secured to the ground floor (not shown) by respective ground securing members 70 and all upper intermediate posts to the ceiling of the building by respective auxiliary securing members 80. Since the lattice walls are securely fastened to the floor and ceiling of the building there is no need to fasten the proximal ends of the lattice walls to the building walls

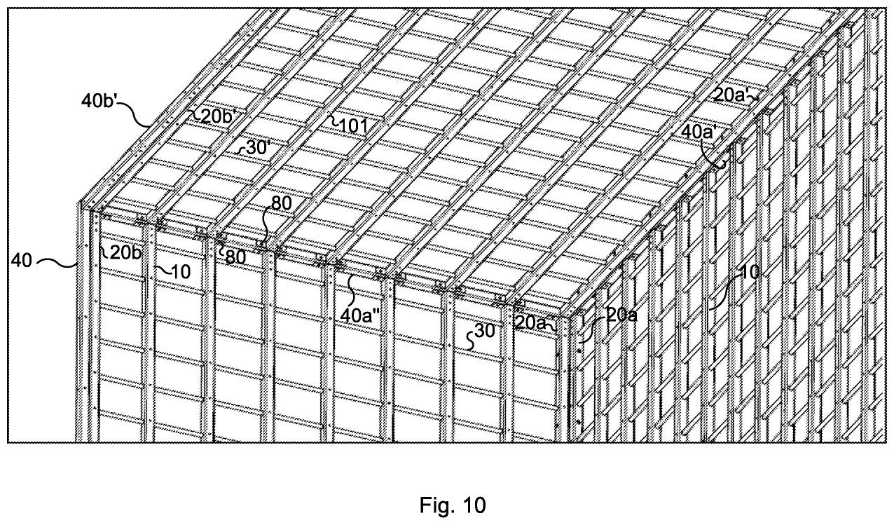

FIG. 10 illustrates how the modular system may be used for assembling a security cage which also comprises a lattice wall ceiling. Here the cage comprises two perpendicularly arranged lattice walls which have been assembled generally as described above. However, here the upper ends of the intermediate posts 10, 20a, 20b of the vertical lattice walls have not been secured to the ceiling of the building. Instead, a lattice ceiling has been assembled in the same manner as described above by assembling intermediate posts 10′, 20a′, 20b′, first bars 30′ and locking posts 40a′, 40b′. It should be noted that these modular components used for forming the lattice ceiling are identical to those forming the vertical lattice walls. The vertical lattice walls and the lattice ceiling have been joined by joining the upper ends of the vertical intermediate posts 10, 20a, 20b of the right hand side vertical wall (as seen in the figure) to a locking post 40a′ of the ceiling. Additionally, the upper ends of the left hand side vertical wall (as seen in the figure) has been secured to corresponding ends of the ceiling's intermediate posts 10′, 20a′, 20b′ via auxiliary securing members 80 and an intermediate post 40a″ which is constituted by a locking post comprised in the modular system and shown in FIGS. 6a-b.

In a not shown embodiment of the invention the modular system comprises at least one intermediate joint post. This post is configured essentially as the intermediate post 10 shown in FIGS. 4a-b and differs from this intermediate post 10 only in that it comprises two longitudinal rows of second screw holes arranged in parallel along the intermediate joint post. Such a intermediate joint post may be used as a junction between two longitudinally aligned first bars, when the length of a lattice wall is longer than the length of the first bars 30. As such instances an end of one first bar is inserted into one of the two primary through openings comprised in a pair of primary through openings of the intermediate joint post and an end of the other first bar is inserted into the other primary through openings of said pair, such that both ends are received at the same level inside the intermediate joint post. Thereafter each end of the first bars are secured to the intermediate joint post by a fixation screw threadedly engaged in a respective second screw hole arranged side by side in the two rows of second screw holes. Such a intermediate joint post may find particular use at installations where all or several first bars are joined longitudinally at the same intermediate post. At other installations requiring prolongation of the first bars it is possible to arrange the joint between the first bars at different intermediate posts.

In another not shown embodiment a lattice wall, for example of the type illustrated in FIG. 1 may be provided with openings such as a door opening or the like. At such arrangements the door frame may be formed of the intermediate and locking posts comprised in the modular system. As readily understood the side jambs of the door opening may be formed of end posts and locking posts. The frame head may be formed of a locking post which is fixed to the intermediate posts arranged above the door opening in a similar manner as locking post 40a″ is secured to the intermediate posts 10′ of the lattice ceiling shown in FIG. 10. It is also readily understood that a door for being hingedly attached to such a door frame also may be assembled by interconnecting first bars, intermediate posts and locking posts comprised in the modular system.

It is realized that the modular system according to the invention is very flexible in that it may be used by combining the modular components in many different ways for constructing lattice walls, ceilings and floors (not shown) as well as security cages having widely differing dimensions and geometries.

Even so, the modular system comprises only a low number of different modular components. If needed the posts 10, 20a, 20b, 40a, 40b and the bars 30, 50 may readily be adapted to various demands simply by cutting or joining two or more posts and/or bars longitudinally. The components of the modular system may be so adapted before delivery to the assembly site thereby eliminating any cutting or other machining on site. Additionally the modular components are comparatively light and have dimensions which make them easy to bring into the assembly site also at buildings where the access ways have limited dimensions.

The invention has mainly been described above with reference to a few embodiments. However, as is readily appreciated by a person skilled in the art, other embodiments than the ones disclosed above are equally possible within the scope of the invention, as defined by the appended patent claims. In the above described embodiments the first direction in which the intermediate posts and locking posts extend is vertical, whereas the first bars extend in a horizontal direction. It is however realized that the first and second directions may have any direction in the space as long as they are essentially perpendicular to each other.

1. A modular system for assembling at least one lattice wall for a security cage, which system comprises;
a plurality of elongate hollow intermediate posts (10, 20a, 20b) arranged to be mounted side by side in at least one row, the intermediate posts thereby extending in parallel in a first direction, each post exhibiting a number of transverse primary through openings (11, 21) arranged in pairs along the post, the primary trough openings of each pair being aligned in a second direction which is perpendicular to the first direction;
a plurality of elongate first bars (30), arranged to be mounted side by side in parallel, extending in the second direction, by insertion through respective pairs of said through openings (11, 21) in a plurality of intermediate posts (10, 20a, 20b) arranged side by side in said row,
at least two locking posts (40a, 40b) arranged to be secured to a first (20a) and a last (20b) intermediate post in said row of intermediate posts; and
securing means (24, 25, 44) for securing the locking posts (40a, 40b) to respective end sides of said first (20a) and last (20b) intermediate posts, which end sides faces away from each other, thereby to lock the first bars (30) from being removed by displacement in the second direction; and
a plurality of fastening brackets (70, 80), each fastening bracket comprising a support portion (72, 82) arranged to be secured to a surrounding floor, wall or ceiling and a insertion portion (71, 81) arranged to be adjustably inserted into an end portion of an intermediate post (10, 20a, 20b) and secured thereto at a desired insertion depth.

2. A modular system according to claim 1, wherein the securing means comprises screws (25) and screw holes (24, 44) arranged in the locking posts (40a, 40b) and in the first (20a) and last (20b) intermediate posts.

3. A modular system according to claim 1, wherein the cross section of the intermediate posts (10, 20a, 20b) is rectangular, preferably square.

4. A modular system according to claim 1, wherein the cross section of the locking posts (40a, 40b) is equal to the cross section of the intermediate posts (10, 20a, 20b).

5. A modular system according to claim 1, further comprising elongate second bars (50) arranged to be inserted longitudinally in the intermediate posts (10, 20a, 20b).

6. A modular system according to claim 1, wherein the plurality of intermediate posts (10, 20a, 20b) comprises at least two end posts (20a, 20b) which are arranged to constitute said first (20a) and last (20b) intermediate posts in the row of intermediate posts, wherein the end posts 820a, 20b) and the locking posts (40a, 40b) exhibit respective screw holes (24, 44) which are arranged for securing a locking post to a respective end post by treading a screw into the locking post from the side of the end post being opposite to the locking post.

7. (canceled)

8. A modular system according to claim 1, further comprising a plurality of joint brackets (60) arranged to be longitudinally inserted into respective end portions of a first and a second intermediate post (10, 20a, 20b) and secured thereto for longitudinal extension of the intermediate posts.

9. A modular system according to claim 1, wherein at least some intermediate posts (10, 20a, 20b) comprise a number screw holes (13, 23) corresponding to the number of pairs of primary through openings (11, 21), each screw hole being arranged perpendicular to and in level with a pair of primary through openings for securing a first bar (30) extending through said pair of primary through openings by means of a screw (26) threadedly engaged the screw hole (13, 23).

10. A modular system according to claim 9, wherein at least one post comprises a number of said screw holes arranged in pairs side by side at a respective pair of primary through openings for securing a respective one of two first bars extending through a respective primary through opening of each pair of primary through openings.

11. A modular system according to claim 1, further comprising blocking means for preventing removal of the securing means when the locking posts have been secured to the first and last intermediate posts.

12. A modular system according to claim 10, wherein the securing means comprises at least one screw with a screw head exhibiting a recess or a protrusion for being engaged by a tool and the blocking means comprises a blocking element arranged to be forced into permanent engagement with said recess or protrusion for preventing insertion of a tool.

13. A modular system according to claim 1, wherein the intermediate posts (10, 20a, 20b), the first bars (30) and the locking posts (40a, 40) comprises steel.

14. A modular system according to claim 5, wherein the second bars (50) have circular cross section.

15. A modular system according to claim 5, wherein the second bars (50) comprises hardened steel.

16. A method of assembling a lattice wall of a security cage comprising the steps of;
providing a plurality of elongate hollow intermediate posts (10, 20a, 20b), each post exhibiting a number of transverse primary through openings (11, 21) arranged in pairs along the post, the primary trough openings of each pair being aligned in a second direction which is perpendicular to the first direction,
providing plurality of fastening brackets (70, 80), each fastening bracket comprising a support portion (72, 82) arranged to be secured to a surrounding floor, wall or ceiling and a insertion portion (71, 81) arranged to be adjustably inserted into an end portion of an intermediate post (10, 20a, 20b) and secured thereto at a desired insertion depth
providing a plurality of elongate first bars (30),
providing at least two locking posts (40a, 40b),
arranging the intermediate posts (10, 20a, 20b) in a row one after the other with an interspace, such that the intermediate posts (10, 20a, 20b) are arranged in parallel in a first direction,
fastening at least some of said intermediate posts to a surrounding floor, wall, ceiling or other external element by means of said fastening brackets (70, 80),
inserting first bars (30) into respective pairs of primary through openings (11, 21) of each intermediate post (10, 20a, 20b), such that the first bars (30) are received in a first (20a) and a last (20b) intermediate post in said row but do not protrude out from respective end sides of said first and last intermediate posts, which end sides faces away from each other,
securing a locking post (40a, 40b) to each of said end sides of the respective first (20a) and last (20b) intermediate post.
